(19) United States
(12) Patent Application Publication
(10) Pub. No.: US 2016/0028176 A1
(43) Pub. Date: Jan. 28, 2016

(54) LINE SYSTEM FOR A VEHICLE

(71) Applicant: Audi AG, Ingolstadt (DE)

(72) Inventor: Jörg Eickstädt, Gaimersheim (DE)

(73) Assignee: Audi AG, Ingolstadt (DE)

(21) Appl. No.: 14/807,566

(22) Filed: Jul. 23, 2015

(30) Foreign Application Priority Data
Jul. 26, 2014 (DE) 10 2014 011 122.9

(51) Int. Cl. H01R 13/00; B60R 16/08; B60R 16/06

(52) U.S. Cl. CPC H01R 13/005; B60R 16/06; B60R 16/08

(57) ABSTRACT

A line system for a vehicle includes a fuel line having an electrically conductive inner layer, a connection element coupled to the fuel line in a connection zone, and an electrically conductive contact element arranged in the connection zone. The contact element is electrically-conductively connected with the inner layer and connectable with a predefined potential. The contact element is arranged on the connection element and has an attachment flange configured for connection with a ground potential and/or a cable harness. The fuel line is placed upon the connection element such as to realize an electrically conductive connection between the contact element and the inner layer of the fuel line.

### CROSS-REFERENCES TO RELATED APPLICATIONS

This application claims the priority of German Patent Application, Ser. No. 10 2014 011 122.9, filed Jul. 26, 2014, pursuant to 35 U.S.C. 119(a)-(d), the disclosure of which is incorporated herein by reference in its entirety as if fully set forth herein.

### BACKGROUND OF THE INVENTION

The present invention relates to a line system for a vehicle.

The following discussion of related art is provided to assist the reader in understanding the advantages of the invention, and is not to be construed as an admission that this related art is prior art to this invention.

Line systems for vehicles normally include at least one fuel line which can be coupled with a connection element at a connection zone. The fuel line can be coupled via the connection element with further fuel lines and/or a fuel tank and/or a fuel rail. When fuel flows through the fuel line, there is a risk of a buildup of an electrostatic charge of the fuel line. There are many ways to dissipate the electric charge. Normally, the provision of an electrically conductive contact element is proposed for electrically conductive connection with an electrically conductive inner layer of the fuel line. The contact element dissipates the electric charge from the inner layer of the fuel line to the outside.

It would be desirable and advantageous to provide an improved line system for a vehicle to obviate prior art shortcomings and to realize an easy-to-make electrically conductive connection between an electrically conductive fuel line and a contact element that dissipates electric charge.

### SUMMARY OF THE INVENTION

According to one aspect of the present invention, a line system for a vehicle includes a fuel line having an electrically conductive inner layer, a connection element coupled to the fuel line in a connection zone, and an electrically conductive contact element arranged in the connection zone, the contact element being electrically-conductively connected with the inner layer and connectable with a predefined potential, with the contact element being arranged on the connection element and having an attachment flange configured for connection with a ground potential and/or a cable harness, with the fuel line being placed upon the connection element such as to realize an electrically conductive connection between the contact element and the inner layer of the fuel line.

In accordance with the present invention, the electrically conductive connection between the contact element and the inner layer can be realized in a single operating step at a same time as the fuel line is coupled with the connection element. As a result, installation time can be shortened. There is no need for additional elements in order to produce the electrically conductive connection between the fuel line and the connection element, because the fuel line presses the contact element against the connection element. The connection element may, for example, connect the fuel line with further fuel lines and/or a fuel tank and/or a fuel rail configured as a fuel pump. The electric charge can be reliably dissipated in almost any region of the line system. Advantageously, the contact element may also be coupled with a ground potential and/or with a cable harness in order to realize a grounding of the corresponding fuel line for example. Coupling with the ground potential may be realized, for example, by coupling the contact element with a vehicle body. As a result of the afore-described electric connection, grounding of fuel-carrying lines can advantageously be achieved in a manner that is durable and can quickly be realized.

According to another advantageous feature of the present invention, the electrically conductive inner layer of the fuel line may be made of metal or an electrically conductive polymer.

According to another advantageous feature of the present invention, the fuel line can have an outer layer which may be made of electrically insulating material, such as, for example, polymer acetate, polymer PTFE, polymer PET, polymer PVC, polyamide, polyethylene, polypropylene, or caoutchouc.

According to another advantageous feature of the present invention, the contact element can have an L-shaped and/or T-shaped cross section. The contact element can thus be produced more cost-efficiently than a stamped-bent part and is easy to produce on a large scale. Moreover, the angle portion of the L-shaped or T-shaped contact element can easily be clamped between the electrically conductive inner layer of the fuel line and a support surface of the connection element.

The configuration of the contact element with an attachment flange enables easy arrangement of plugs upon the attachment flange to further transport the electric charge.

According to another advantageous feature of the present invention, a fastening assembly can be provided to pre-fix the contact element onto the connection element. As a result, the contact element can be held captive on the connection element and a shifting of the contact element is prevented when the fuel line is slipped over the contact element.

According to another advantageous feature of the present invention, the fastening assembly can be configured as a latch connection and/or clip connection. The fastening assembly may hereby be implemented by providing the contact element with a first fastening element which cooperates with a second fastening element of the connection element. The first fastening element may, for example, be configured as elastic tab and/or hook, whereas the second fastening element may be configured as opening and/or undercut and/or shoulder.

According to another advantageous feature of the present invention, the connection element can have at least one support surface for support of the contact element. Advantageously, the support surface may resist a force required for sliding the fuel line over the connection element. The fuel line is normally press-fitted under a great force application onto the connection element, with the support surface being able to provide also a stop for the fuel line. The provision of the support surface advantageously prevents hereby a shift of the contact element and thus improper placement of the fuel line upon the contact element, when this force is applied.

According to another advantageous feature of the present invention, the connection element can have a recess for accommodation of the contact element. Advantageously, the recess may be configured as a flat depression. The provision of the recess facilitates the placement of the fuel line upon the contact element.

According to another advantageous feature of the present invention, the contact element may be made of high-quality steel.

According to another advantageous feature of the present invention, the connection element may have at least one undulated and/or rib-shaped elevation in the connection zone. The presence of such an undulated and/or rib-shaped elevation causes a widening of the fuel line to thereby realize a simple durable connection between the fuel line and the connection element. Moreover, the undulated and/or rib-shaped elevation may be oriented such that the placement of the fuel line upon the contact element requires less force than a removal of the fuel line.

According to another advantageous feature of the present invention, the connection element can be configured as coupling element and/or element of a quick-action connection and/or as attachment flange. The fuel line can thus be connected to further components and/or fuel lines via the coupling element and/or the element of a quick-action connection and/or the attachment flange, and a complementing further connection element.

### BRIEF DESCRIPTION OF THE DRAWING

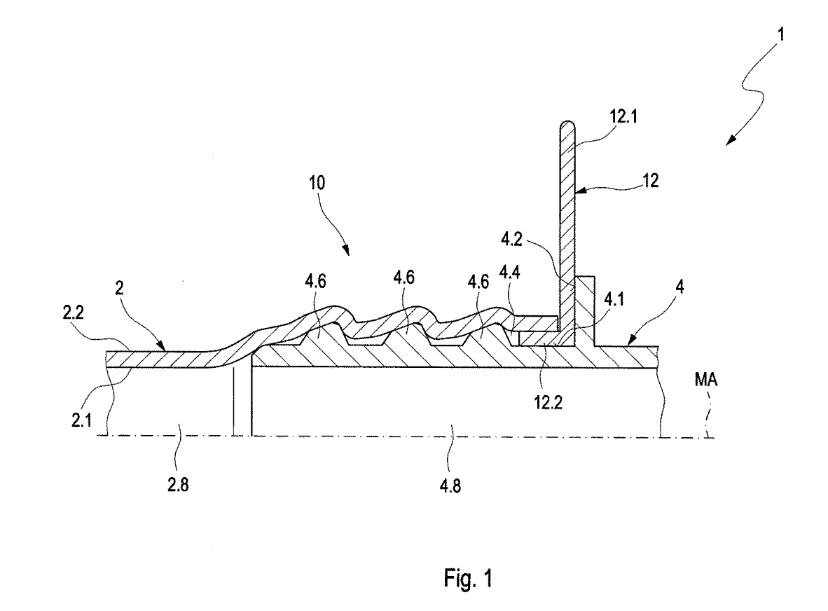

Other features and advantages of the present invention will be more readily apparent upon reading the following description of currently preferred exemplified embodiments of the invention with reference to the accompanying drawing, in which the sole FIG. 1 shows a schematic sectional view of a line system for a vehicle in accordance with the present invention.

### DETAILED DESCRIPTION OF PREFERRED EMBODIMENTS

The depicted embodiment is to be understood as illustrative of the invention and not as limiting in any way. It should also be understood that the figure is not necessarily to scale and that the embodiment is sometimes illustrated by graphic symbols, phantom lines, diagrammatic representations and fragmentary views. In certain instances, details which are not necessary for an understanding of the present invention or which render other details difficult to perceive may have been omitted.

Turning now to FIG. 1, there is shown a schematic sectional view of a line system for a vehicle in accordance with the present invention, generally designated by reference numeral 1. The line system 1 includes at least one fuel line 2 having an electrically conductive inner layer 2.1 and coupled with a connection element 4 in a connection zone 10. Arranged in the connection zone 10 is an electrically conductive contact element 12 which is electrically-conductively connected with the inner layer 2.1 of the fuel line 2. Using the contact element 12 enables dissipation of electric charges caused by fuel flowing through the fuel line 2.

The contact element 12 is arranged on the connection element 4, and the fuel line 12 is slipped over or placed upon the connection element 4 such as to realize an electrically conductive connection between the contact element 12 and the inner layer 2.1.

The line system 1 shown in FIG. 1 is only illustrated by way of a section thereof to show the coupling of the fuel line 2 with the connection element 4. The fuel line 2 and the connection element 4 extend axis-symmetrical to a center axis MA and have each a hollow space 2.8, 4.8. The fuel line 2 and the connection element 4 are coupled in such a way that a fluid-tight connection is established in the connection zone 10. Although not shown in greater detail, the line system 1 may, of course, include further couplings with further connection elements.

The electrically conductive inner layer 2.1 of the fuel line 2 may be made of metal or an electrically conductive polymer. The fuel line 2 has an outer layer 2.2 which may be made of electrically insulating material, such as, for example, polymer acetate, polymer PTFE, polymer PET, polymer PVC, polyamide, polyethylene, polypropylene, or caoutchouc.

As is readily apparent form FIG. 1, as the fuel line 2 is placed over the contact element 12 and onto the connection element 4, an easy-to-make and lasting electrically conductive connection is established between the electrically conductive fuel line 2 and the contact element 12 which dissipated the electric charge. There is no need for additional elements in order to realize the electrically conductive connection between the fuel line 2 and the connection element 4, since the fuel line 2 presses the contact element 12 against the connection element 4. The connection element 4 may hereby serve to connect the fuel line 2 with further, not shown, fuel lines and/or with a fuel pump and/or with a fuel tank. Dissipation of the electric charge is thus possible in almost any region of the line system 1.

In the non-limiting example as shown in FIG. 1, the contact element 12 has an L-shaped cross section. It is, of course, also conceivable to configure the contact element 12 with a T-shaped cross section. As a result, the contact element 12 has an angled portion 12.2 which can easily be clamped between the electrically conductive inner layer 2.1 of the fuel line 2 and a support surface 4.1 of the connection element 4. The contact element 12 further includes an attachment flange 12.1 upon which not shown plugs can easily be attached or slipped over to further transport the electric charge. Using the plugs, the contact element 12 may, for example, coupled with the body or a cable harness of the vehicle in order to ground the fuel line 2 for example.

The contact element 12 may be made of high-quality steel. The contact element 12 may, of course, also be made from other electrically conductive materials. As an alternative to the plug connection, the further transport of the electric charge may also be established via a crimped connection or a permanent soldered connection.

Although not shown in greater detail, the line system 1 can have a fastening assembly to pre-fix the contact element 12 on the connection element 4. The fastening assembly may hereby be configured as latch connection and/or clip connection, with the contact element 12 having at least a first fastening element for cooperation with a second fastening element of the connection element 4. The first fastening element may, for example, be configured as elastic tab and/or hook, whereas the second fastening element may be configured as opening and/or undercut and/or shoulder. As a result of the pre-fix, the contact element 12 can be held captive on the connection element 4 so as to prevent a shift of the contact element 12, when the fuel line 2 is slipped over the contact element 12.

As is further readily apparent form FIG. 1, the contact element 12 is supported on at least one support surface 4.2 of the connection element 4. The support surface 4.2 resist hereby a force required to slip the fuel line 2 over the connection element .4. The fuel line 2 is normally press-fitted under a great force application onto the connection element 4, with the support surface 4.2 being able to provide also a stop for the fuel line 2. The provision of the support surface 4.2 advantageously prevents hereby a shift of the contact element 12 and thus improper placement of the fuel line 2 upon the contact element 12, when this force is applied.

FIG. 1 further shows the accommodation of the contact element 12 in a recess 4.4 of the connection element 4. The recess 4.4 is configured as flat depression and facilitates the placement of the fuel line 2 upon the contact element 12.

As can further be seen from FIG. 1, the connection element 4 has undulated and/or rib-shaped elevations 4.6 in the connection zone 10. The presence of such undulated and/or rib-shaped elevations 4.6 causes a widening of the fuel line 2 to thereby realize a simple durable connection between the fuel line 2 and the connection element 4. Moreover, the undulated and/or rib-shaped elevations 4.6 may be oriented such that the placement of the fuel line 2 upon the contact element 12 requires less force than a removal of the fuel line 2.

The connection element 4 can be configured as coupling element and/or element of a quick-action connection and/or as attachment flange. The fuel line 2 can thus be connected to further components and/or fuel lines via the coupling element and/or the element of a quick-action connection and/or the attachment flange, and a complementing further connection element.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A line system for a vehicle, comprising:
a fuel line having an electrically conductive inner layer;
a connection element coupled to the fuel line in a connection zone; and
an electrically conductive contact element arranged in the connection zone, said contact element being electrically-conductively connected with the inner layer and connectable with a predefined potential, said contact element being arranged on the connection element and having an attachment flange configured for connection with a ground potential and/or a cable harness,
said fuel line being placed upon the connection element such as to realize an electrically conductive connection between the contact element and the inner layer of the fuel line.

2. The line system of claim 1, wherein the contact element has an L-shaped and/or T-shaped cross section.

3. The line system of claim 1, further comprising a fastening assembly configured to pre-fix the contact element onto the connection element.

4. The line system of claim 3, wherein the fastening assembly is configured as a latch connection and/or clip connection.

5. The line system of claim 1, wherein the connection element has at least one support surface for support of the contact element.

6. The line system of claim 1, wherein the connection element has a recess for accommodation of the contact element.

7. The line system of claim 1, wherein the contact element is made of high-quality steel.

8. The line system of claim 1, wherein the connection element has at least one undulated and/or rib-shaped elevation in the connection zone.

9. The line system of claim 1, wherein the connection element is configured as coupling element and/or element of a quick-action connection and/or as attachment flange.

10. The line system of claim 1, wherein the electrically conductive inner layer of the fuel line is made of metal or an electrically conductive polymer.

11. The line system of claim 1, wherein the fuel line has an outer layer made of electrically insulating material.

12. The line system of claim 11, wherein the electrically insulating material is polymer acetate, polymer PTFE, polymer PET, polymer PVC, polyamide, polyethylene, polypropylene, or caoutchouc.
